(19) United States
(12) Patent Application Publication
(10) Pub. No.: US 2020/0132081 A1
(43) Pub. Date: Apr. 30, 2020

(54) TURBO BLOWER WITH IMPELLER UNIT-COOLING FAN FOR FUEL CELL

(71) Applicant: TURBOWIN CO., LTD., Cheongju-si (KR)

(72) Inventor: Minsoo KIM, Daejeon (KR)

(73) Assignee: TURBOWIN CO., LTD., Cheongju-si (KR)

(21) Appl. No.: 16/400,345

(22) Filed: May 1, 2019

(30) Foreign Application Priority Data
Oct. 30, 2018 (KR) 10-2018-0130829

(51) Int. Cl. F04D 25/08; F04D 17/10

(52) U.S. Cl. CPC F04D 25/082; H01M 8/04014; F04D 17/10

(57) ABSTRACT

Disclosed is a turbo blower with an impeller unit-cooling fan for a fuel cell and, more particularly, a turbo blower with an impeller unit-cooling fan for a fuel cell, the turbo blower improving efficiency and durability of an impeller unit by preventing an increase in temperature by cooling the impeller unit, which generates high-pressure air, using a cooling structure that uses both of an air cooling type and a water cooling type.

### BACKGROUND OF THE INVENTION

### Field of the Invention

The present invention relates to a turbo blower with an impeller unit-cooling fan for a fuel cell and, more particularly, a turbo blower with an impeller unit-cooling fan for a fuel cell, the turbo blower improving efficiency and durability of an impeller unit by preventing an increase in temperature by cooling the impeller unit, which generates high-pressure air, using a cooling structure that uses both of an air cooling type and a water cooling type.

### Description of the Related Art

Due to problems such as the steady rise in oil price according to the depletion of fossil energy and the environmental pollution according to the exhaust gas emitted from vehicles, the development of vehicles using a fuel cell is being even more desperately needed.

The fuel cell is a cell capable of generating electrical energy in the course of the reaction of hydrogen and oxygen. Accordingly, a fuel cell vehicle includes a fuel cell stack, a hydrogen supplier for supplying the hydrogen to the fuel cell stack, and an air blower etc. for supplying the compressed air to the fuel cell stack.

Particularly, in case of the air blower for fuel cell, it requires a low flow rate and a high pressure. Also, it requires a high durability and a low noise, and a broad driving range.

Such an air blower for fuel cell is a device for supplying an oxygen required to generate electricity in the fuel cell stack and a key component of the fuel cell system. Also, it includes the process of compressing the atmosphere so as to reduce the passage resistance generated in the process of being passed to the fuel cell stack.

Also, the kinds of the air blowers for fuel cell are determined by levels of air pressure and flow rate required in the fuel cell stack. For example, in the area of low pressure and high flow rate, screw or displacement type compressor is applied. In the area of relatively high flow rate and low pressure, a turbo type compressor is applied in general.

In the case of the screw compressor, it is operated at a rpm lower than that of the turbo type compressor and have an intuitively understandable compression structure. However, it has heavy and bulky shortcomings. In the case of the turbo type compressor, it has inexpensive but small and simple structure. However, it is necessary to secure the lubrication structure appropriate for high speed rotation.

In the present invention, it concentrates upon the experiments on the cooling method and cooling structure of the conventional the fuel cell air blower for vehicle. Accordingly, it is to provide the air blower for fuel cell capable of improving efficiency and durability by trapping the heat of the air blower for fuel cell.

As the prior art related to a turbo blower for fuel cell having an impeller cooling fan, “an air blower for a fuel cell vehicle” of Korea Patent registration No. 10-1735042 (hereinafter referred to as “Patent Literature 1”) is disclosed.

As shown in FIG. 5A, it relates to an air blower for a fuel cell vehicle having an air flowing groove formed at an area contacting an outer peripheral portion of a bearing thereby making it possible to improve durability by reducing a shaft load and a cooling water passage formed in a motor case, thereby making it possible to further increase cooling efficiency.

As further prior art, “an air blower for a fuel cell vehicle” of Korea Patent publication No. 10-2016-0097884 (hereinafter referred to as “Patent Literature 2”) is disclosed.

The Patent Literature 2 relates to an air blower for a fuel cell vehicle, including a housing, an impeller support part, an impeller housing, a rear cover, and a blower motor. The housing forms the exterior of the air blower. The impeller support part is coupled to the front side of the housing and supports an impeller inducing outer air. The impeller housing is coupled to the impeller support part to cover the impeller and has an air inlet inducing air and an air outlet discharging compressed air. The rear cover is coupled to the rear side of the housing. The blower motor is installed on the interior of the housing and drives the rotation of the impeller. The impeller support part can include a first flow path allowing the air induced by the impeller to be introduced into the housing. According to the present invention, since the air blower has no separate drainage hose and no port for drainage, the air blower can be easily managed, and there is no need to replace a drainage hose. Moreover, a rotor of the blower motor is able to be sufficiently cooled to reduce deterioration of durability of a bearing and lift-shortening due to heat of the rotor.

As described above, the Patent Literatures 1 and 2 are the same technical field as the present invention and are partially identical with the present invention in terms of the subject matters to be solved by the invention (object of the invention). However, there are differences in the resolving means that is, components and the effects thereof between them.

Thus, the technical features thereof are different from each other.

### PATENT LITERATURE

Patent Literature 1: Korean Patent Registration No. 10-1735042 (May 04, 2017)

Patent Literature 2: Korean Patent publication No. 10-2016-0097884 (Aug. 18, 2016)

### SUMMARY OF THE INVENTION

The present invention has been made in an effort to solve the problems of the related art, and an object of the present invention is to provide a turbo blower with an impeller unit-cooling fan for a fuel cell, the turbo blower improving efficiency and durability by reducing an increase in temperature of an impeller unit by forming a cooling structure that simultaneously uses an air cooling type and a water cooling type.

In particular, an object of the present invention is to provide a turbo blower with an impeller unit-cooling fan for a fuel cell, the turbo blower reducing an increase in temperature of an impeller unit by naturally suctioning air into a second air suction compartment of a blower casing unit using the impeller unit, and by guiding the suctioned air to a specific path.

According to an aspect of the invention to achieve the object described above, there is provided a turbo blower with an impeller unit-cooling fan for a fuel cell for solving problems with a turbo blower for a fuel cell that are generated by high-temperature heat by maximizing cooling effect of the turbo blower for a fuel cell and improving efficiency and durability, by cooling the second air suction compartment using both of air cooling and water cooling by positioning and coupling the impeller unit producing compressed air in the blower casing unit divided into a first air suction compartment and the second air suction compartment, the turbo blower including: a blower casing unit that guides flow and discharge of suctioned air; and an impeller unit that is disposed in the blower casing unit, suctions air, and generates flow of the air, wherein the blower casing unit that prevents an increase in temperature of the impeller unit by guiding air suctioned inside to a specific path includes: a first air suction compartment into which air suctioned by an impeller flows; a second air suction compartment into which air suctioned by the impeller unit-cooling fan flows; a first air suction duct that allows air to be suctioned into the first air suction compartment by the impeller; a first air discharge duct that allows the air suctioned through the first air suction compartment to be compressed and discharged to a fuel cell stack by the impeller unit; a second air suction duct that allows air to be suctioned into the second air suction compartment by the impeller unit-cooling fan; a second air discharge duct that allows the air, which has been suctioned through the second air suction duct and has cooled the impeller unit, to be discharged; a cooling air path formed by the second air suction duct and the second air discharge duct; and an impeller unit-water cooler formed adjacent to the impeller unit disposed in the second air suction compartment and having a cooling water inflow circulation groove cooling the impeller unit using the flow of cooling water supplied from the outside, so efficiency and durability of the turbo blower for a fuel cell are maximized through a cooling method simultaneously using both of air cooling and water cooling by reducing an increase in temperature of the impeller unit by cooling a portion of the impeller unit rotating at high speed in the second air suction compartment using the flow of air guided to a specific path, wherein the impeller unit allowing air to be suctioned into the first air suction compartment and the second air suction compartment includes: a stator; a rotor; an impeller; and the impeller unit-cooling fan spaced in the opposite direction apart from an impeller coupled to an end of a rotor, coupled to the other end of the rotor, disposed in the second air suction compartment, and suctioning air into the second air suction compartment, and an increase in temperature of the impeller unit that is rotated at high speed is reduced, and efficiency and durability are maximized.

### BRIEF DESCRIPTION OF THE DRAWINGS

The above and other objects, features and advantages of the present invention will be more apparent from the following detailed description taken in conjunction with the accompanying drawings, in which:

FIG. 1 is a view showing the configuration of a turbo blower with an impeller unit-cooling fan for a fuel cell of the present invention;

FIG. 2 is a perspective view of the turbo blower with an impeller unit-cooling fan for a fuel cell of the present invention;

FIG. 3 is a cross-sectional view of the turbo blower with an impeller unit-cooling fan for a fuel cell of the present invention;

FIG. 4 is a flow chart illustrating an operation and a flow of suctioned air in the turbo blower with an impeller unit-cooling fan for a fuel cell of the present invention; and

FIG. 5A and 5B are a representative view of the conventional art on the turbo blower with an impeller unit-cooling fan for a fuel cell of the present invention.

### REFERENCE SIGNS LIST

1: turbo blower with an impeller unit-cooling fan for a fuel cell of the present invention

100: blower casing unit

110: first air suction compartment

120: second air suction compartment

130: first air suction duct

140: first air discharge duct

150: second air suction duct

160: second air discharge duct

170: cooling air path

180: impeller unit-water cooler

181: cooling water inflow circulation groove

200: impeller unit

210: stator

220: a rotor

230: impeller

240: impeller unit-cooling fan

S100: impeller unit operation step

S200: first air suction step

S300: first air flow step

S400: air compression step

S500: compressed air discharge step

S600: compressed air supply step

S700: second air suction step

S800: second air flow step

S900: impeller unit cooling step

S1000: air discharge step

### DETAILED DESCRIPTION OF THE PREFERRED EMBODIMENT

Hereinafter, the invention may be variously modified and may have various embodiments, and specific embodiments are exemplified in the drawings and described in detail. However, the invention is not limited to specific embodiments, and it should be understood that the invention includes all modifications, equivalents, and substitutes included within the spirit and technical scope of the invention. The embodiments are provided to describe the invention in more detail to persons skilled in the art. Accordingly, the shape of each element illustrated in the drawings may be exaggerated to emphasize more obvious description and, when it is determined that specific description about the related art may blur the gist of the invention, detailed description thereof is omitted.

Hereinafter, functions, components, and actions of the turbo blower with an impeller unit-cooling fan for a fuel cell of the present invention will be described in more detail with reference to the accompanying drawings.

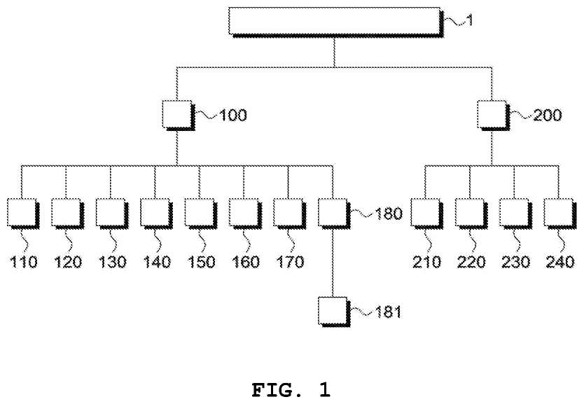

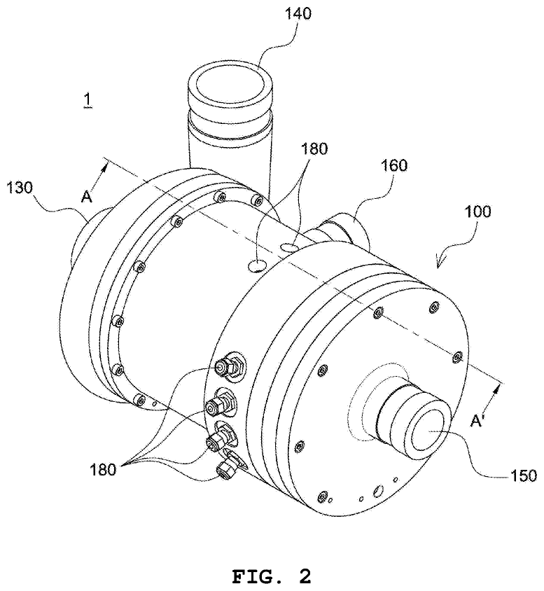

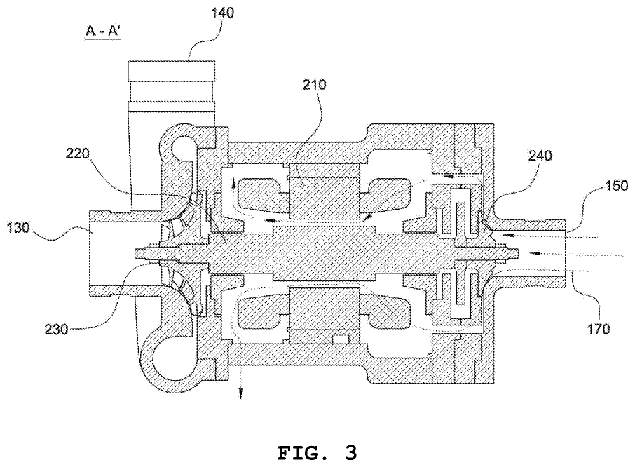

FIG. 1 is a view showing the configuration of a turbo blower with an impeller unit-cooling fan for a fuel cell of the present invention, FIG. 2 is a perspective view of the turbo blower with an impeller unit-cooling fan for a fuel cell of the present invention, and FIG. 3 is a cross-sectional view of the turbo blower with an impeller unit-cooling fan for a fuel cell of the present invention.

As shown in FIGS. 1 to 3, the present invention is characterized in that a turbo blower (1) with an impeller unit-cooling fan for a fuel cell includes:

a blower casing unit (100) that guides flow and discharge of suctioned air; and

an impeller unit (200) that is disposed in the blower casing unit (100), suctions air, and generates flow of the air,

in which the blower casing unit (100) includes:

a second air suction duct (150) that allows air to be suctioned into a second air suction compartment (120) of the blower casing unit (100) by an impeller unit-cooling fan (240); and

a second air discharge duct (160) through which the air suctioned through the second air suction duct (150) is discharged,

the impeller unit (200) includes:

the impeller unit-cooling fan (240) spaced in the opposite direction apart from an impeller (230) coupled to an end of a rotor (220), coupled to the other end of the rotor (220), disposed in the second air suction compartment (120), and suctioning air into the second air suction compartment (120), and

that an increase in temperature of the impeller unit (200) that is rotated at high speed is reduced, and efficiency and durability are maximized.

That is, the present invention, which is a turbo blower for a fuel cell that supplies oxygen to a fuel cell stack, is for solving problems with a turbo blower for a fuel cell (a short lifespan and deterioration of efficiency) that are generated by high-temperature heat by maximizing cooling effect of the turbo blower for a fuel cell and improving the efficiency and durability of the turbo blower for a fuel cell, by cooling the second air suction compartment (120) using both of air cooling and water cooling by positioning and coupling the impeller unit (120) producing compressed air in the blower casing unit (100) divided into a first air suction compartment (110) and the second air suction compartment (120).

In more detail, the blower casing unit (100) that prevents an increase in temperature of the impeller unit (200) by guiding air suctioned inside to a specific path includes:

as shown in FIG. 3,

a first air suction compartment (110) into which air suctioned by an impeller (230) flows;

a second air suction compartment (120) into which air suctioned by the impeller unit-cooling fan (240) flows;

a first air suction duct (130) that allows air to be suctioned into the first air suction compartment (110) by the impeller (230);

a first air discharge duct (140) that allows the air suctioned through the first air suction duct (130) to be compressed and discharged to a fuel cell stack by the impeller unit (200);

a second air suction duct (150) that allows air to be suctioned into the second air suction compartment (120) by the impeller unit-cooling fan (240);

a second air discharge duct (160) that allows the air, which has been suctioned through the second air suction duct (150) and has cooled the impeller unit (200), to be discharged;

a cooling air path (170) formed by the second air suction duct (150) and the second air discharge duct (160); and

an impeller unit-water cooler (180) formed adjacent to the impeller unit (200) disposed in the second air suction compartment (120) and having a cooling water inflow circulation groove (181) cooling the impeller unit (200) using the flow of cooling water supplied from the outside,

in which the efficiency and durability of the turbo blower for a fuel cell are maximized through a cooling method using both of air cooling and water cooling, by reducing an increase in temperature of the impeller unit (200) by cooling a portion of the impeller unit (200) rotating at high speed in the second air suction compartment (120) using the flow of air guided to a specific path.

That is, the present invention improve efficiency and durability of a turbo blower for a fuel cell by, as described above, preventing an increase in temperature of the inside of the second air suction compartment (120) by cooling the turbo blower for a fuel cell in the cooling method using both of air cooling and water cooling, and further by inducing thermal equilibrium.

Meanwhile, the blower casing unit (100), that is, the impeller unit (200) allowing air to be suctioned into the first air suction compartment (110) and the second air suction compartment (120) includes:

equally to the configuration of a turbo blower for a fuel cell of the related art,

a stator (210)

a rotor (220);

an impeller (230), and

the present invention further includes a impeller unit-cooling fan (240) spaced in the opposite direction apart from an impeller (230) coupled to an end of a rotor (220), coupled to the other end of the rotor (220), disposed in the second air suction compartment (120), and suctioning air into the second air suction compartment (120).

The impeller unit-cooling fan (240), as shown in FIG. 3, is positioned in the second air suction compartment (120) but is coupled to the other end of the rotor (220) that rotates the impeller (230), so there is no need for separate power for rotating the impeller unit-cooling fan (240).

That is, the present invention is a technology of cooling a portion of the impeller unit (200) positioned in the second air suction compartment (120) using a cooling method that uses both of air cooling and water cooling through organic combination of the blower casing unit (100) and the impeller unit (200), in detail, organic combination of the blower casing unit (100) configured such that the impeller unit (200) is combined with the first air suction compartment (110) and the second air suction compartment (120), and combination with the impeller unit (200) correspondingly formed to be organically combined with the blower casing unit (100).

The organic combination relationship of the blower casing unit (100) of the present invention maximizes the effect that the turbo blower for a fuel cell can achieve through combination with the impeller unit (200) formed to correspond to the organic combination relationship.

For example,

First,

the space in which air is suctioned in the blower casing unit (100) is divided into the first air suction compartment (110) and the second air suction compartment (120) such that compressed air that is supplied to the fuel cell stack is discharged by compressing the air suctioned into the impeller (230) from the first air suction compartment (110), and

the stator (210) and the rotor (220) that rotate the impeller (230) are positioned in the second air suction compartment (120), so the air suctioned by the impeller unit-cooling fan (240) rotated by rotation of the rotor (220) is guided to the cooling air path (170) such that the air flowing through the cooling air path (170) comes in contact with the stator (210) and the rotor (220), thereby preventing an increase in temperature of the impeller unit (200), that is, prevent an increase in temperature of the second air suction compartment (120).

Second

an increase in temperature of the impeller unit (200) is prevented by the impeller unit-water cooler (180) formed adjacent to the impeller unit (200) together with the air flowing through the cooling air path (170).

That is, the stator (210) and the rotor (220) of the impeller unit (200) are cooled by the air flowing through the cooling air path (170), and

the impeller unit-water cooler (180) prevents an increase in temperature of a portion of the impeller unit (200), that is, an increase in temperature of the second air suction compartment (120) by cooling the stator (210) of the impeller unit (200) and the inner walls of the second air suction compartment (120), using cooling water.

Third

the air suctioned into the second air suction compartment (120) through the impeller unit-cooling fan (240) easily flows by the cooling air path (170) formed by the second air suction duct (150) and the second air discharge duct (160) and is discharged to the second air discharge duct (160) after passing the stator (210) and the rotor (220) of the impeller unit (200), thereby achieving smooth air circulation in the second air suction compartment (120).

That is, the present invention has been designed to cool the impeller unit (200) by forming a cooling structure that uses both of air cooling and water cooling through the organic combination of the blower casing unit (100) and the impeller unit (200) by focusing on the cooling method of the impeller unit (200) as a part of maximizing efficiency and durability of a turbo blower for a fuel cell.

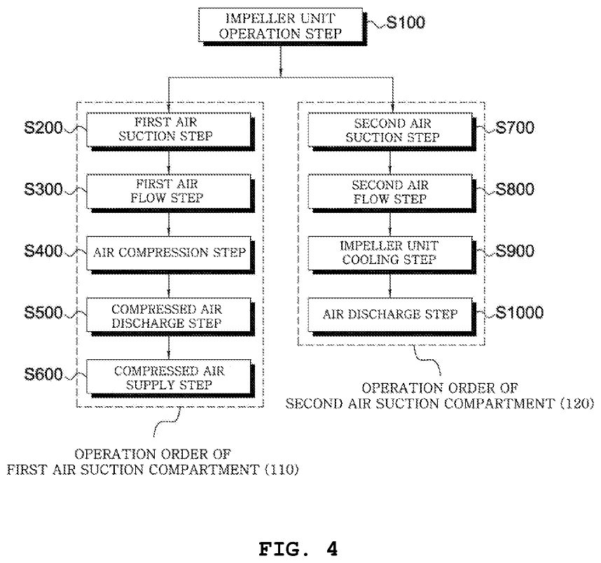

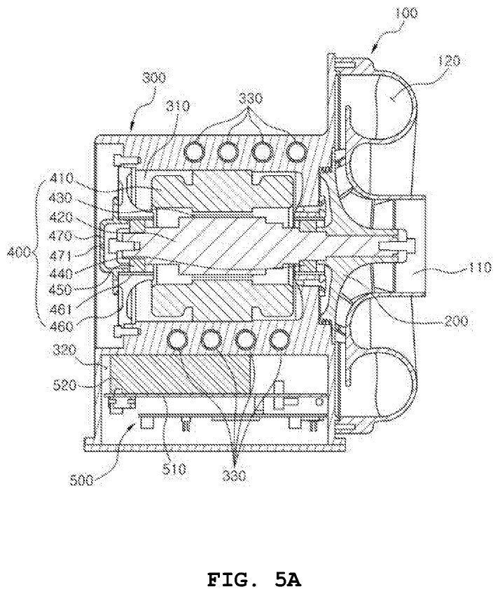

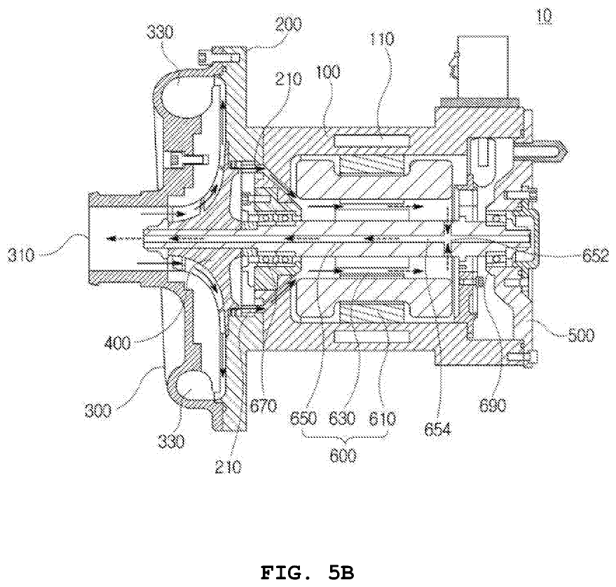

Meanwhile, the operation of the turbo blower with an impeller unit-cooling fan for a fuel cell that is the present invention and the flow of air are briefly described with reference to FIG. 4.

The impeller unit (200) is rotated by energy supplied from the outside ( [symbol] S100, impeller unit operation step)

air is suctioned into the first air suction compartment (110) by the impeller (230) rotating at high speed ( [symbol] S200, first air suction step), and

simultaneously, air is suctioned into the second air suction compartment (120) by the impeller (230) rotating at high speed ( [symbol] S700, second air suction step).

The air suctioned in the first air suction compartment (110) through the first air suction duct (130) by high-speed rotation of the impeller (230) is suctioned into the impeller (230) ( [symbol] S300, first air flow step),

and the air suctioned into the impeller (230) is compressed ( [symbol] S400, air compression step), and

is discharged to the first air discharge duct (140) ( [symbol] S500, compressed air discharge step).

The compressed air discharged to the first air discharge duct (140) is supplied to the fuel cell stack combined with the first air discharge duct (140) ( [symbol] S600, compressed air supply step).

Further, the air suctioned through the second air suction duct (150) by high-speed rotation of the impeller unit-cooling fan (240) flows through the cooling air path (170) that is discharged to the second air discharge duct (160) ( [symbol] S800, second air flow step), and

a portion of the impeller unit (200) positioned in the second air suction compartment (120) is cooled by the air flowing through the cooling air path (170) ( [symbol] S900, impeller unit cooling step),

thereby preventing an increase in temperature of the second air suction compartment (120).

The air suctioned in the second air suction compartment (120) flows through the cooling air path (170), thereby cooling a portion of the impeller unit (200) and is discharged through the second air discharge duct (160) ( [symbol] S1000, air discharge step).

Cooling of the second air suction compartment (120) using water is continuously performed in the process from the second air suction step (S700) to the air discharge step (S1000) by the impeller unit-water cooler (180), whereby the second air suction compartment (120) is cooled.

That is, the present invention relates to a turbo blower for a fuel cell of which the efficiency and durability are maximized by compressing and transmitting suctioned air to the fuel cell stack but separately configuring a space for transmitting compressed air and a space for cooling the impeller unit (200).

For reference, it is preferable that the first air suction compartment (110) and the second air suction compartment (120) are separately sealed so that the air suctioned into the first air suction compartment (110) by the impeller (230) does not flow into the second air suction compartment (120) and the air suctioned into the second air suction compartment (120) by the impeller unit-cooling fan (240) does not flow into the first air suction compartment (110).

In the configuration and operations above, according to the present invention described above, an increase in temperature is prevented by cooling the impeller unit producing compressed air with a cooling structure using both of an air cooling type and a water cooling type.

In particular, the cooling method that uses air cooling cools the impeller unit using the flow of air naturally suctioned into the second air suction compartment of the blower casing unit by the impeller unit-cooling fan.

That is, the temperature of the impeller unit is decreased by the flow of air suctioned into the second air suction compartment.

Accordingly, efficiency and durability of the turbo blower for a fuel cell is maximized.

Further, since the first air suction compartment for producing compressed air to be supplied to a fuel cell stack is separately formed, the amount of compressed air is constantly maintained.

That is, the present invention can be considered as being very effective for securing and maintaining high efficiency and economical efficiency by completely cooling the turbo blower for a fuel cell.

While the present invention has been described with respect to the specific embodiments, it will be apparent to those skilled in the art that various changes and modifications may be made without departing from the spirit and scope of the invention as defined in the following claims.

### INDUSTRIAL APPLICABILITY

The present invention relates to a turbo blower with an impeller unit-cooling fan for a fuel cell and can be applied to contribute to improving various industrial fields such as a manufacturing and a retail business of the turbo blower, particularly, an industry related to a turbo blower for a fuel cell for supplying compressed air to a fuel cell stack, and the general industry requiring compressed air.

What is claimed is:

1. A turbo blower (1) with an impeller unit-cooling fan for a fuel cell for solving problems with a turbo blower for a fuel cell that are generated by high-temperature heat by maximizing cooling effect of the turbo blower for a fuel cell and improving efficiency and durability, by cooling the second air suction compartment (120) using both of air cooling and water cooling by positioning and coupling the impeller unit (120) producing compressed air in the blower casing unit (100) divided into a first air suction compartment (110) and the second air suction compartment (120), the turbo blower (1) comprising:
a blower casing unit (100) that guides flow and discharge of suctioned air; and
an impeller unit (200) that is disposed in the blower casing unit (100), suctions air, and generates and flow of the air,
wherein the blower casing unit (100) that prevents an increase in temperature of the impeller unit (200) by guiding air suctioned inside to a specific path includes:
a first air suction compartment (110) into which air suctioned by an impeller (230) flows;
a second air suction compartment (120) into which air suctioned by the impeller unit-cooling fan (240) flows;
a first air suction duct (130) that allows air to be suctioned into the first air suction compartment (110) by the impeller (230);
a first air discharge duct (140) that allows the air suctioned through the first air suction duct (130) to be compressed and discharged to a fuel cell stack by the impeller unit (200);
a second air suction duct (150) that allows air to be suctioned into the second air suction compartment (120) by the impeller unit-cooling fan (240);
a second air discharge duct (160) that allows the air, which has been suctioned through the second air suction duct (150) and has cooled the impeller unit (200), to be discharged;
a cooling air path (170) formed by the second air suction duct (150) and the second air discharge duct (160); and
an impeller unit-water cooler (180) formed adjacent to the impeller unit (200) disposed in the second air suction compartment (120) and having a cooling water inflow circulation groove (181) cooling the impeller unit (200) using the flow of cooling water supplied from the outside,
so efficiency and durability of the turbo blower for a fuel cell are maximized through a cooling method simultaneously using both of air cooling and water cooling by reducing an increase in temperature of the impeller unit (200) by cooling a portion of the impeller unit (200) rotating at high speed in the second air suction compartment (120) using the flow of air guided to a specific path,
wherein the impeller unit (200) allowing air to be suctioned into the first air suction compartment (110) and the second air suction compartment (120) includes:
a stator (210);
a rotor (220);
an impeller (230); and
the impeller unit-cooling fan (240) spaced in the opposite direction apart from an impeller (230) coupled to an end of a rotor (220), coupled to the other end of the rotor (220), disposed in the second air suction compartment (120), and suctioning air into the second air suction compartment (120), and
an increase in temperature of the impeller unit (200) that is rotated at high speed is reduced, and efficiency and durability are maximized.
